(19) United States
(12) Patent Application Publication
(10) Pub. No.: US 2004/0059050 A1
(43) Pub. Date: Mar. 25, 2004

(54) Hardenable powder paints, method for the production thereof, and mixing system for powder paints

(76) Inventors: Christopher Hilger, Munster (DE); Susanne Piontek, Munster (DE); Michael Mauss, Neustadt (DE); Gunther Etzrodt, Stuttgart (DE); Robert Bayer, Sinsheim (DE)

Correspondence Address: BASF CORPORATION, ANNE GERRY SABOURIN, 26701 TELEGRAPH ROAD, SOUTHFIELD, MI, 48034-2442, US

(21) Appl. No.: 10/415,201

(22) PCT Filed: Nov. 27, 2001
(86) PCT No.: PCT/EP01/13792

(30) Foreign Application Priority Data
Nov. 27, 2000 (DE) 10058860.3

(51) Int. Cl. C08K 3/00

(52) U.S. Cl. 524/589

(57) ABSTRACT

A curable powder coating material preparable by applying at least one dispersion and/or at least one solution (I) comprising (A) at least one functional constituent of a powder coating material, (B) at least one solvent, and, if desired, (C) at least one oligomeric and/or polymeric constituent, with partial, essentially complete or complete evaporation of the solvent or solvents (B) to the surface of dimensionally stable particles (II); and also a novel mixer system and a novel process for preparing and/or subsequently adjusting the material composition and/or performance properties profile of curable powder coating materials, using at least one dispersion and/or at least one solution (I).

The present invention relates to novel curable powder coating materials, especially color and/or effect powder coating materials. The present invention additionally relates to a novel process for preparing and/or subsequently adjusting the material composition and/or the performance properties profile of curable powder coating materials, especially curable, color and/or effect powder coating materials. The present invention further relates to a novel mixer system for preparing and subsequently adjusting the material composition and/or performance properties profile of curable powder coating materials. The present invention relates not least to the use of the novel curable powder coating materials for automotive OEM finishing, for the interior and exterior coating of constructions, for the coating of doors, windows and furniture, for industrial coating, including coil coating, container coating and the impregnation and/or coating of electrical components, and for the coating of white goods, including domestic appliances, boilers and radiators.

In the text below, the curable powder coating materials are referred to for short as “powder coating materials”.

Powder coating materials and processes for preparing them are known, for example, from the BASF Coatings AG brochures “Pulverlacke fur industrielle Anwendungen” [Powder coatings for industrial applications], January 2000, or “Coatings Partner, Powder coatings special”, 1/2000. The powder coating materials comprise curable precursors of thermosetting plastics which are applied in powder form to preferably metallic substrates. This is normally done using powder coating units as described in the abovementioned brochures. The two fundamental advantages of powder coating materials are manifested in such units: the complete or substantial absence of organic solvents, and the ease of recycling the powder coating overspray into the coating process.

Irrespective of the particular powder coating units and processes used, the powder coating materials are applied in a thin layer to the substrate and melted, forming a continuous powder coating layer, after which the resultant coating is cooled. The cure is effected during or after the melting of the powder coating layer. The minimum temperature for the cure is preferably above the melting range of the powder coating material, so that melting and curing are separate from one another. This has the advantage that the powder coating melt, owing to its comparatively low viscosity, flows out well before the cure sets in.

The preparation of the powder coating materials embraces a very large number of steps and is therefore a comparatively complex process. First of all, the binders of the powder coating materials must be coarsely milled. Subsequently, the individual components of the powder coating materials, such as binders and functional constituents such as crosslinking agents, pigments or typical powder coating additives are mixed with one another and the mixtures are extruded in special extruders. The extrudate is discharged and cooled, for example, on a cooling belt. The extrudate fragments are prefractionated, then finely milled and screened (with the oversize being returned to the fine mill), after which the resultant powder coating material is weighed and packed. The composition of the powder coating materials prepared by this process is dependent solely on the original constituents weighed in; it is not possible to correct the composition subsequently.

The process is complicated further if the materials prepared are not only pigment-free powder clearcoat materials or pigmented powder coating materials in a single shade, but also are pigmented powder coating materials in different shades. In that case, all of the equipment, such as premixers, extruders, cooling belt, crushers, fine mill, sieving machine and packaging machine, must be completely taken apart and cleaned, since a single blue powder coating particle in a yellow coating, for example, can be seen at first glance. This cleaning operation may take up several days, and is/are thus therefore very costly.

Moreover, the production process has a further key disadvantage. Shade adjustment and/or correction by mixing or tinting steps is/are thus impossible; instead, the shade is laid down solely by the original constituents weighed in. Whether the finished color and/or effect powder coating material, or the coating produced from it, ultimately has the desired shade and/or optical effect is then dependent on numerous different process parameters and on the particular implementation of the process, so that it becomes extremely difficult to work out the reason for off-specification batches.

Moreover, the preparation of color and/or effect powder coating materials may be accompanied by a range of problems which can be attributed to the deficient incorporation and incomplete dispersion of the color and/or effect pigments. This is especially the case with transparent pigments and effect pigments. Overall, it leads to increased pigment consumption and to quality problems.

Pigmented powder coating materials appear transparent when the pigment particles are <15 nm. These small primary pigment particles, however, have a strong tendency to agglomerate. The agglomerates can be disrupted only with great effort in special mills. When they are incorporated into the powder coating materials, it is not generally possible, even using special extruders, to produce transparent colorations with pigments that are hard to disperse, such as wet-chemically prepared, transparent iron oxide pigments, carbon-black pigments or perylene pigments, without inhomogeneities.

In the case of effect pigments based on platelet-shaped pigment particles, their incorporation into the powder coating materials is frequently observed to be accompanied by a change in the particle size and morphology. The colorations obtained are then coloristically less attractive than the coatings produced with these effect pigments on the basis of wet coating materials, and lack the brightness and the typical deep-seated satin sheen. Aluminum effect pigments turn gray, and in the case of mica effect pigments the optical effects can no longer be observed at all. These problems can be alleviated at least partly using what is known as the bonding process. However, this process is extremely laborious, and the recyclability and weathering stability of the resultant powder coatings are limited.

Attempts have therefore been made to configure the preparation process for powder coating materials, especially for color and/or effect powder coating materials, in such a way that the disadvantages described above are avoided.

For instance, the international patent application WO 92/00342 discloses a process for preparing pigmented powder coating materials in which a powder coating melt is atomized. Two powder coating melts of different composition may be supplied to an atomizing apparatus. Whether this process can be used for the controlled tinting of color and/or effect powder coating materials is not evident from the patent application.

The American patent U.S. Pat. No. 3,759,864 A discloses a process for preparing pigmented powder coating materials or pulverulent pigment concentrates, in which solutions of binders in organic solvents are mixed with pigments dispersed in organic solvents. The resultant dispersions are dried, after which the resultant solids must be fractionated and milled in a customary and known manner.

The British patent application GB 1,197,053 discloses the preparation of a pigment concentrate which is easy to incorporate by mixing, which involves mixing aqueous dispersions of pigments and aqueous binder dispersions with one another and then spray-drying the resultant mixtures.

A comparable process is known from the German patent application DE 25 22 986 A1. The patent application states that the conditions of the spray drying may be set in such a way that the pigment concentrates are obtained directly in the desired particle sizes.

The preparation of pigment concentrates is also disclosed in the international patent application WO 95/31507 and the European patent application EP 1 026 212 A1. Herein as well it is proposed to mix aqueous pigment dispersions and aqueous binder dispersions with one another and to spray-dry the mixtures. It is additionally proposed that the resultant pigment concentrates should be processed in a customary and known manner together with the other constituents of powder coating materials to give color-imparting powder coating materials. However, the process is difficult if not impossible to implement with effect pigments.

The processes described above may possibly improve the incorporation of pigments during the customary and known preparation of color and/or effect powder coating materials. However, they are unable to remove the key disadvantage that the shades and/or optical effects continue to be dependent on the original constituents weighed in and that subsequent tinting of color and/or effect powder coating materials which deviate from the given specification is not possible.

The problems set out above which occur during the incorporation of pigments into powder coating materials are also encountered, of course, during the incorporation of other functional constituents of powder coating materials, such as crosslinking agents, color and/or effect pigments, fluorescent pigments, electrically conductive pigments and/or pigments providing magnetic screening, metal powders, pigments imparting scratch resistance, organic dyes, organic and inorganic, transparent or opaque fillers and/or nanoparticles and/or auxiliaries and/or additives such as UV absorbers, light stabilizers, free-radical scavengers, devolatilizers, slip additives, polymerization inhibitors, crosslinking catalysts, thermally labile free-radical initiators, photoinitiators, thermally curable reactive diluents, reactive diluents curable with actinic radiation, adhesion promoters, leveling agents, film-forming auxiliaries, flame retardants, corrosion inhibitors, free-flow aids, waxes and/or flatting agents, for example. Here again, the respective amount is dependent on the original constituents weighed in; subsequent correction is impossible. As in the case of a change in the pigments, moreover, the unit must be thoroughly cleaned when there is a change in the functional constituents.

It is obvious that the powder coating materials which differ from the given specifications in their composition and their performance properties profile, especially as regards the shades and/or the optical effects, are unable to give coatings which meet the specifications.

It is an object of the present invention to find novel powder coating materials, especially color and/or effect powder coating materials, from which the disadvantages of the prior art are absent and which instead have a composition and profile of technical properties, especially as regards the shades and/or the optical effects, that meet the particular given specifications. The intention is to make full use of the potential of the functional constituents, especially the color and/or effect potential of the pigments, in the coatings produced from the novel powder coating materials. Moreover, the novel powder coating materials should be simple to prepare.

A further object of the present invention was to find a novel process for preparing powder coating materials, from which the disadvantages of the prior art are absent and which instead makes it possible to prepare powder coating materials differing in their material composition in succession without laborious cleaning of the units employed in preparing powder coating materials. The novel process should ensure that the powder coating materials prepared therewith always fully meet the given specifications in terms of the composition and the profile of technical properties, especially as regards the shades and/or the optical effects. Furthermore, the novel process should make it possible to make subsequent adjustments to powder coating materials that have already been prepared but which differ from the given specifications, so that they meet those specifications, with the consequence that few if any off-specification batches still occur.

It was a further object of the present invention to find a novel mixer system for powder coating materials which permits not only the preparation of powder coating materials but also the subsequent adjustment of their material composition and their performance properties profile, especially as regards their shades and/or their optical effects and recyclability, especially that of powder coating materials comprising effect pigments.

Accordingly, we have found the novel curable powder coating material preparable by applying at least one dispersion (I) and/or at least one solution (II) comprising

(A) at least one functional constituent of a powder coating material and

(B) at least one solvent

with partial, essentially complete or complete evaporation of the solvent or solvents (B) to the surface of dimensionally stable particles (II).

In the text below, the novel curable powder coating material is referred to as the “powder coating material of the invention”.

We have also found the novel mixer system for preparing curable powder coating materials and/or for subsequently adjusting the material composition and/or the performance properties profile of curable powder coating materials, comprising

(I) at least two adjustment modules, each comprising a dispersion or solution comprising

(A) at least one functional constituent of a powder coating material and

(B) at least one solvent

and

(II) at least one solids module comprising dimensionally stable particles.

In the text below, the novel mixer system for preparing curable powder coating materials and/or for subsequently adjusting the material composition and/or the performance properties profile of curable powder coating materials is referred to as the “mixer system of the invention”.

We have additionally found the novel process for preparing curable powder coating materials and/or for subsequently adjusting the material composition and/or the performance properties profile of the curable powder coating materials by mixing at least one oligomeric and/or polymeric constituent with at least one functional constituent, which comprises

(1) preparing dimensionally stable particles (II) comprising at least one oligomeric and/or polymeric constituent and coating them with

(2) at least one dispersion (I) and/or at least one solution (I) comprising

(A) at least one functional constituent of a powder coating material and

(B) at least one solvent

with partial, essentially complete or complete evaporation of the solvent or solvents (B).

In the text below, the novel process for preparing curable powder coating materials and/or for subsequently adjusting the material composition and/or the performance properties profile of curable powder coating materials by mixing at least one oligomeric and/or polymeric constituent with at least one functional constituent is referred to as the “process of the invention”.

Further subject matter of the invention will emerge from the description.

In the light of the prior art it was surprising for the skilled worker that with the aid of the process of the invention and/or of the mixer system of the invention, powder coating materials are obtained in which the pigments, especially the effect pigments and/or the fluorescent, electrically conductive and/or magnetically screening pigments, are fully dispersed. This makes it possible to reduce significantly the pigment content of the powder coating materials of the invention in comparison with the conventional powder coating materials without any reduction in the hiding power. Moreover, with the aid of the process of the invention and/or of the mixer system of the invention, it is possible to prepare powder coating materials which are readily recyclable. Furthermore, the powder coating materials of the invention provide coatings of particularly high quality.

The starting product essential to the invention for the preparation of the powder coating material of the invention and for the implementation of the process of the invention, and also the constituent essential to the invention of the mixer system of the invention, is at least one dispersion (I) and/or at least one solution (I) which comprises at least one functional constituent of a powder coating material (A) and at least one solvent (B). Furthermore, the dispersion or solution (I) may comprise at least one oligomeric and/or polymeric constituent (C) which may be different than the binder of the dimensionally stable particles (II) or identical with it.

The functional constituent (A) may be readily soluble in the solvent (B), so that the solution is molecularly disperse. Moreover, the functional constituent (A) may be of comparatively low solubility, so that depending on its concentration it is present partly in solution and partly in dispersion. The functional constituent (A) may also be of very low solubility or entirely insoluble, so that it forms essentially a dispersion. It is also possible, however, to employ mixtures of soluble and insoluble functional constituents (A).

Suitable functional constituents (A) are all typical powder coating constituents with the exception of the substances mentioned under (C).

Examples of suitable, typical powder coating constituents (A) are crosslinking agents, color and/or effect pigments, fluorescent pigments, electrically conductive pigments and/or magnetically screening pigments, metal powders, soluble organic dyes, organic and inorganic, transparent or opaque fillers and/or nanoparticles and/or auxiliaries and/or additives such as UV absorbers, light stabilizers, free-radical scavengers, devolatilizers, slip additives, polymerization inhibitors, crosslinking catalysts, thermally labile free-radical initiators, photoinitiators, thermally curable reactive diluents, reactive diluents curable with actinic radiation, adhesion promoters, leveling agents, film-forming auxiliaries, flame retardants, corrosion inhibitors, free-flow aids, waxes and/or flatting agents. The constituents (A) may be employed individually or as mixtures.

In the context of the present invention, actinic radiation means electromagnetic radiation such as near infrared, visible light, UV radiation or x-rays, especially UV radiation, or corpuscular radiation such as electron beams.

Examples of suitable crosslinking agents are polyisocyanates.

The polyisocyanates contain on average at least 2.0, preferably more than 2.0 and in particular more than 3.0 isocyanate groups per molecule. There is in principle no upper limit on the number of isocyanate groups; in accordance with the invention, however, it is of advantage for the number not to exceed 15, preferably 12, with particular preference 10, with very particular preference 8.0, and in particular 6.0.

Examples of suitable polyisocyanates are isocyanato-containing polyurethane prepolymers which can be prepared by reacting polyols with an excess of diisocyanates and which are preferably of low viscosity.

Examples of suitable diisocyanates are isophorone diisocyanate (i.e., 5-isocyanato-isocyanatomethyl-1,3,3-trimethylcyclohexane), 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-isocyanato-(4-isocyanatobut-1-yl)-1,3,3-trimethylcyclohexane, 1-isocyanato-2-(3-isocyanatoprop-1-yl)cyclohexane, 1-isocyanato-2-(3-isocyanatoeth-1-yl)cyclohexane, 1-isocyanato-2-(4-isocyanatobut-1-yl)cyclohexane, 1,2-diisocyanatocyclobutane, 1,3-diisocyanatocyclobutane, 1,2-diisocyanatocyclopentane, 1,3-diisocyanatocyclopentane, 1,2-diisocyanatocyclohexane, 1,3-diisocyanatocyclohexane, 1,4-diisocyanatocyclohexane, dicyclohexylmethane 2,4′-diisocyanate, trimethylene diisocyanate, tetramethylene diisocyanate, pentamethylene diisocyanate, hexamethylene diisocyanate (HDI), ethylethylene diisocyanate, trimethylhexane diisocyanate, heptamethylene diisocyanate or diisocyanates derived from dimeric fatty acids, as sold under the commercial designation DDI 1410 by Henkel and described in the patents WO 97/49745 and WO 97/49747, especially 2-heptyl-3,4-bis(9-isocyanatononyl)-1-pentylcyclohexane, or 1,2-, 1,4- or 1,3-bis(isocyanatomethyl)cyclohexane, 1,2-, 1,4- or 1,3-bis(2-isocyanatoeth-1-yl)cyclohexane, 1,3-bis(3-isocyanatoprop-1-yl)cyclohexane, 1,2-, 1,4- or 1,3-bis(4-isocyanatobut-1-yl)cyclohexane or liquid bis(4-isocyanatocyclohexyl)methane with a trans/trans content of up to 30% by weight, preferably 25% by weight and in particular 20% by weight, as described in the patent applications DE 44 14 032 A1, GB 1220717 A1, DE 16 18 795 A1 or DE 17 93 785 A1, preferably isophorone diisocyanate, 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-isocyanato-(4-isocyanatobut-1-yl)-1,3,3-trimethylcyclohexane, 1-isocyanato-2-(3-isocyanatoprop-1-yl)cyclohexane, 1-isocyanato-2-(3-isocyanatoeth-1-yl)cyclohexane, 1-isocyanato-2-(4-isocyanatobut-1-yl)cyclohexane or HDI, especially HDI.

It is also possible to use polyisocyanates containing isocyanurate, biuret, allophanate, iminooxadiazinedione, urethane, urea, carbodiimide and/or uretdione groups, which are prepared in a customary and known manner from the diisocyanates described above. Examples of suitable preparation processes and polyisocyanates are known, for example, from the patents CA 2,163,591 A, U.S. Pat. No. 4,419,513, U.S. Pat. No. 4,454,317 A, EP 0 646 608 A, U.S. Pat. No. 4,801,675 A, EP 0 183 976 A1, DE 40 15 155 A1, EP 0 303 150 A1, EP 0 496 208 A1, EP 0 524 500 A1, EP 0 566 037 A1, U.S. Pat. No. 5,258,482 A1, U.S. Pat. No. 5,290,902 A1, EP 0 649 806 A1, DE 42 29 183 A1 or EP 0 531 820 A1.

Further examples of suitable crosslinking agents are blocked polyisocyanates.

Examples of suitable blocking agents for preparing the blocked polyisocyanates are the blocking agents known from the U.S. patent U.S. Pat. No. 4,444,954 A or U.S. Pat. No. 5,972,189 A, such as

i) phenols such as phenol, cresol, xylenol, nitrophenol, chlorophenol, ethylphenol, t-butylphenol, hydroxybenzoic acid, esters of this acid, or 2,5-di-tert-butyl-4-hydroxytoluene;

ii) lactams, such as ε-caprolactam, δ-valerolactam, γ-butyrolactam or β-propiolactam;

iii) active methylenic compounds, such as diethyl malonate, dimethyl malonate, ethyl or methyl acetoacetate, or acetylacetone;

iv) alcohols such as methanol, ethanol, n-propanol, isopropanol, n-butanol, isobutanol, t-butanol, n-amyl alcohol, t-amyl alcohol, lauryl alcohol, ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, propylene glycol monomethyl ether, methoxymethanol, 2-(hydroxyethoxy)phenol, 2-(hydroxypropoxy)phenol, glycolic acid, glycolic esters, lactic acid, lactic esters, methylolurea, methylolmelamine, diacetone alcohol, ethylenechlorohydrin, ethylenebromohydrin, 1,3-dichloro-2-propanol, 1,4-cyclohexyldimethanol or acetocyanohydrin;

v) mercaptans such as butyl mercaptan, hexyl mercaptan, t-butyl mercaptan, t-dodecyl mercaptan, 2-mercaptobenzothiazole, thiophenol, methylthiophenol or ethylthiophenol;

vi) acid amides such as acetoanilide, acetoanisidinamide, acrylamide, methacrylamide, acetamide, stearamide or benzamide;

vii) imides such as succinimide, phthalimide or maleimide;

viii) amines such as diphenylamine, phenylnaphthylamine, xylidine, N-phenylxylidine, carbazole, aniline, naphthylamine, butylamine, dibutylamine or butylphenylamine;

ix) imidazoles such as imidazole or 2-ethylimidazole;

x) ureas such as urea, thiourea, ethyleneurea, ethylenethiourea or 1,3-diphenylurea;

xi) carbamates such as phenyl N-phenylcarbamate or 2-oxazolidone;

xii) imines such as ethyleneimine;

xiii) oximes such as acetone oxime, formaldoxime, acetaldoxime, acetoxime, methyl ethyl ketoxime, diisobutyl ketoxime, diacetyl monoxime, benzophenone oxime or chlorohexanone oximes;

xiv) salts of sulfurous acid such as sodium bisulfite or potassium bisulfite;

xv) hydroxamic esters such as benzyl methacrylohydroxamate (BMH) or allyl methacrylohydroxamate; or

xvi) substituted pyrazoles, ketoximes, imidazoles or triazoles; and also

mixtures of these blocking agents, especially dimethylpyrazole and triazoles, malonic esters and acetoacetic esters, dimethylpyrazole and succinimide or butyl diglycol and trimethylolpropane.

Further examples of suitable crosslinking agents are all known aliphatic and/or cycloaliphatic and/or aromatic, low molecular mass, oligomeric and polymeric polyepoxides, based, for example, on bisphenol A or bisphenol F. Examples of suitable polyepoxides also include the polyepoxides obtainable commercially under the designations Epikote® from Shell, Denacol® from Nagase Chemicals Ltd., Japan, such as, for example, Denacol EX-411 (pentaerythritol polyglycidyl ether), Denacol EX-321 (trimethylolpropane polyglycidyl ether), Denacol EX-512 (polyglycerol polyglycidyl ether), and Denacol EX-521 (polyglycerol polyglycidyl ether), or the glycidyl ester of trimellitic acid or triglycidyl isocyanurate (TGIC).

As crosslinking agents it is also possible to use tris(alkoxycarbonylamino)triazines (TACT) of the general formula

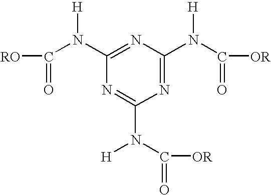

Examples of suitable tris(alkoxycarbonylamino)triazines (B) are described in the patents U.S. Pat. No. 4,939,213 A, U.S. Pat. No. 5,084,541 A, and EP 0 624 577 A1. Use is made in particular of the tris(methoxy-, tris(butoxy- and/or tris(2-ethylhexoxycarbonylamino)triazines.

The methyl/butyl mixed esters, the butyl/2-ethylhexyl mixed esters, and the butyl esters are of advantage. They have the advantage over the straight methyl ester of better solubility in polymer melts, and also have less of a tendency to crystallize out.

Further crosslinking agents are amino resins, examples being melamine resins. It is possible here to use any amino resin suitable for transparent topcoats or clearcoats or a mixture of such amino resins. Particularly suitable are the customary and known amino resins some of whose methylol and/or methoxymethyl groups have been defunctionalized by means of carbamate or allophanate groups. Crosslinking agents of this kind are described in the patents U.S. Pat. No. 4,710,542 A and EP 0 245 700 B1 and also in the article by B. Singh and coworkers, “Carbamylmethylated Melamines, Novel Crosslinkers for the Coatings Industry” in Advanced Organic Coatings Science and Technology Series, 1991, Volume 13, pages 193 to 207. The amino resins may also be employed as binders (C).

Further examples of suitable crosslinking agents are beta-hydroxyalkylamides such as N,N,N′,N′-tetrakis(2-hydroxyethyl)adipamide or N,N,N′,N′-tetrakis(2-hydroxypropyl)adipamide.

A further possibility is to use carboxylic acids, especially saturated, straight-chain, aliphatic dicarboxylic acids having 3 to 20 carbon atoms in the molecule, especially dodecanedioic acid.

Further examples of suitable crosslinking agents are siloxanes, especially siloxanes containing at least one trialkoxy- or dialkoxysilane group.

Which crosslinking agents are employed in each individual case is guided by the complementary reactive functional groups which are present in the binders of the dimensionally stable particles or in the powder coating materials.

Examples of suitable complementary reactive functional groups for use in accordance with the invention are summarized in the following overview. In the overview, the variable R is an acyclic or cyclic aliphatic, an aromatic and/or an aromatic-aliphatic (araliphatic) radical; the variables R′ and R″ are identical or different aliphatic radicals or are linked to one another to form an aliphatic or heteroaliphatic ring.

### Overview: Examples of Complementary Reactive Functional Groups

| Binder | and Crosslinking agent or |
|---|---|
| Crosslinking agent | and Binder |
| —SH | —C(O)—OH |
| —NH₂ | —C(O)—O—C(O)— |
| —OH | —NCO |
| —O—(CO)—NH—(CO)—NH₂ | —NH—C(O)—OR |
| —O—(CO)—NH₂ | —CH₂—OH |
| >NH | —CH₂—O—R |
| | —NH—CH₂—O—R |
| | —NH—CH₂—OH |
| | —N(—CH₂—O—R)₂ |
| | —NH—C(O)—CH(—C(O)OR)₂ |
| | —NH—C(O)—CH(—C(O)OR)(—C(O)—R) |
| | —NH—C(O)—NR′R″ |
| | >Si(OR)₂ |
| | 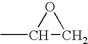 |
| | 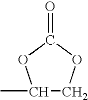 |
| —C(O)—OH | 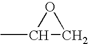 |
| | —C(O)—N(CH₂—CH₂—OH)₂ |

Complementary reactive functional groups which are especially suitable for use in the powder coating materials of the invention are

carboxyl groups on the one hand and epoxide groups and/or beta-hydroxyalkylamide groups on the other, and also

hydroxyl groups on the one hand and blocked and unblocked isocyanate groups or urethane or alkoxymethylamino groups on the other.

Examples of suitable effect pigments are metal flake pigments such as commercial aluminum bronzes, aluminum bronzes chromated in accordance with DE 36 36 183 A1, and commercial stainless-steel bronzes, and also nonmetallic effect pigments, such as pearlescent pigments and interference pigments, for example, platelet-shaped effect pigments based on iron oxide having a shade from pink to brownish red, or liquid-crystalline effect pigments. For further details, reference is made to Römpp Lexikon Lacke und Druckfarben, Georg Thieme Verlag, 1998, page 176, “Effect pigments” and pages 380 and 381, “Metal oxide-mica pigments” to “Metal pigments”, and to the patent applications and patents DE 36 36 156 A1, DE 37 18 446 A1, DE 37 19 804 A1, DE 39 30 601 A1, EP 0 068 311 A1, EP 0 264 843 A1, EP 0 265 820 A1, EP 0 283 852 A1, EP 0 293 746 A1, EP 0 417 567 A1, U.S. Pat. No. 4,828,826 A or U.S. Pat. No. 5,244,649 A.

Examples of suitable inorganic color pigments are white pigments such as titanium dioxide, zinc white, zinc sulfide or lithopones; black pigments such as carbon black, iron-manganese black or spinel black; color pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinel phases and corundum phases or chrome orange; or yellow iron oxide, nickel titanium yellow, chrome titanium yellow, cadmium sulfide, cadmium zinc sulfide, chrome yellow or bismuth vanadate.

Examples of suitable organic color pigments are monoazo pigments, disazo pigments, anthraquinone pigments, benzimidazole pigments, quinacridone pigments, quinophthalone pigments, dicetopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments or aniline black.

For further details, reference is made to Römpp Lexikon Lacke und Druckfarben, Georg Thieme Verlag, 1998, pages 180 and 181, “Iron blue pigments” to “Black iron oxide”, pages 451 to 453, “Pigments” to “Pigment volume concentration”, page 563, “Thioindigo pigments”, page 567, “Titanium dioxide pigments”, pages 400 and 467, “Naturally occurring pigments”, page 459, “Polycyclic pigments”, page 52, “Azomethine pigments”, “Azo pigments”, and page 379, “Metal complex pigments”.

Examples of fluorescent pigments (daylight fluorescent pigments) are bis(azomethine) pigments.

Examples of suitable electrically conductive pigments are titanium dioxide/tin oxide pigments.

Examples of magnetically screening pigments are pigments based on iron oxides or chromium dioxide.

Examples of suitable metal powders are powders of metals and metal alloys of aluminum, zinc, copper, bronze or brass.

Suitable soluble organic dyes are lightfast organic dyes with little or no tendency to migrate from the powder coating material of the invention and from the coatings produced from it. The migration tendency may be estimated by the skilled worker on the basis of his or her general knowledge in the art and/or determined with the aid of simple preliminary rangefinding experiments, in tinting tests, for example.

Examples of suitable organic and inorganic fillers are chalk, calcium sulfates, barium sulfate, silicates such as talc, mica or kaolin, silicas, oxides such as aluminum hydroxide or magnesium hydroxide, or organic fillers such as polymer powders, especially polyamide powders or polyacrylonitrile powders. For further details, reference is made to Römpp Lexikon Lacke und Druckfarben, Georg Thieme Verlag, 1998, pages 250 ff., “Fillers”.

Preference is given to employing mica and talc if the intention is to improve the scratch resistance of the coatings produced from the powder coating materials of the invention.

It is also advantageous to use mixtures of platelet-shaped inorganic fillers such as talc or mica and nonplatelet-shaped inorganic fillers such as chalk, dolomite, calcium sulfates, or barium sulfate, since by this means the viscosity and rheology may be adjusted very effectively.

Examples of suitable transparent fillers are those based on silicon dioxide, aluminum oxide or zirconium oxide, but especially nanoparticles on this basis.

Suitable constituents (A) further include auxiliaries and/or additives such as UV absorbers, light stabilizers, free-radical scavengers, devolatilizers, slip additives, polymerization inhibitors, crosslinking catalysts, thermally labile free-radical initiators, photoinitiators, thermally curable reactive diluents, reactive diluents curable with actinic radiation, adhesion promoters, leveling agents, film-forming auxiliaries, flame retardants, corrosion inhibitors, free-flow aids, waxes and/or flatting agents, which may be used individually or as mixtures.

Examples of suitable thermally curable reactive diluents are positionally isomeric diethyloctanediols or hydroxyl-containing hyperbranched compounds or dendrimers, as described in the patent applications DE 198 09 643 A1, DE 198 40 605 A1 or DE 198 05 421 A1.

Examples of suitable reactive diluents curable with actinic radiation are those described in Römpp Lexikon Lacke und Druckfarben, Georg Thieme Verlag, Stuttgart, New York, 1998, on page 491 under the head-word “Reactive diluents”.

Examples of suitable thermally labile free-radical initiators are organic peroxides, organic azo compounds or C—C-cleaving initiators such as dialkyl peroxides, peroxocarboxylic acids, peroxodicarbonates, peroxide esters, hydroperoxides, ketone peroxides, azo dinitriles or benzpinacol silyl ethers.

Examples of suitable crosslinking catalysts are bismuth lactate, citrate, ethylhexanoate or dimethylolpropionate, dibutyltin dilaurate, lithium decanoate or zinc octoate, amine-blocked organic sulfonic acids, quaternary ammonium compounds, amines, imidazole and imidazole derivatives such as 2-styrylimidazole, 1-benzyl-2-methylimidazole, 2-methylimidazole and 2-butylimidazole, as described in the Belgian patent no. 756,693, or phosphonium catalysts such as ethyltriphenylphosphonium iodide, ethyltriphenylphosphonium chloride, ethyltriphenylphosphonium thiocyanate, ethyltriphenylphosphonium acetate-acetic acid complex, tetrabutylphosphonium iodide, tetrabutylphosphonium bromide and tetrabutylphosphonium acetate-acetic acid complex, as described, for example, in the US patents U.S. Pat. No. 3,477,990 A or U.S. Pat. No. 3,341,580 A.

Examples of suitable photoinitiators are described in Römpp Chemie Lexikon, 9^{th}, expanded and revised, edition, Georg Thieme Verlag, Stuttgart, Vol. 4, 1991, or in Römpp Lexikon Lacke und Druckfarben, Georg Thieme Verlag, Stuttgart, 1998, pages 444 to 446.

Examples of suitable antioxidants are hydrazines and phosphorus compounds.

Examples of suitable light stabilizers are HALS compounds, benzotriazoles or oxalanilides.

Examples of suitable free-radical scavengers and polymerization inhibitors are organic phosphites or 2,6-di-tert-butylphenol derivatives.

Examples of suitable devolatilizers are diazadicycloundecane or benzoin; further examples of the functional constituents (A) listed above and also of further functional constituents (A) are described in detail in the textbook “Lackadditive” [Additives for coatings] by Johan Bieleman, Wiley-V C H, Weinheim, N.Y., 1998.

Preference is given to the use of color and/or effect pigments.

Suitable solvents (B) include organic and inorganic solvents. It is preferred to use solvents in which the constituents (C) described below are soluble and/or dispersible.

Examples of suitable inorganic solvents are water, supercritical carbon dioxide, and liquid nitrogen.

Examples of suitable solvents (B) are aliphatic and alicyclic ketones, ethers, alcohols, aliphatic carboxylates, lactones and aromatic hydrocarbons and also their halogenated derivatives, such as acetone, hexafluoroacetone, isobutanol, hexafluoro-2-propanol, ethyl acetate, N-methylpyrrolidone, toluene or xylene. Of these solvents (B), the low-boiling examples, preferably those boiling below 100° C., are of advantage and are therefore employed with preference in accordance with the invention. Acetone is very particularly advantageous.

The solution or dispersion (I) may further also comprise at least one oligomeric and/or polymeric constituent (C). Preferably, this constituent (C) is compatible with the binder or binders of the dimensionally stable particles (II) described below. Preferably, constituent (C) is identical with the binder of the dimensionally stable particles (II).

As constituent (C) it is possible to employ any desired oligomeric or polymeric resins. In accordance with the invention it is of advantage to use oligomeric and polymeric resins (C) which are also present as binders in the dimensionally stable particles. Further advantages result if the constituents (C) are materially identical with the binders.

Oligomers are resins containing from at least 2 to 15 monomer units in their molecule. In the context of the present invention, polymers are resins containing at least 10 repeating monomer units in their molecule. For further details of these terms, reference is made to Römpp Lexikon Lacke und Druckfarben, Georg Thieme Verlag, Stuttgart, New York, 1998, “Oligomers”, page 425.

Examples of suitable constituents (C) are random, alternating and/or block linear and/or branched and/or comb addition (co)polymers of ethylenically unsaturated monomers, or polyaddition resins and/or polycondensation resins. For further details of these terms, reference is made to Römpp Lexikon Lacke und Druckfarben, Georg Thieme Verlag, Stuttgart, New York, 1998, page 457, “Polyaddition” and “Polyaddition resins (polyadducts)”, and also pages 463 and 464, “Polycondensates”, “Polycondensation” and “Polycondensation resins”, and also pages 73 and 74, “Binders”.

Examples of suitable addition (co)polymers are (meth)acrylate (co)polymers or partially saponified polyvinyl esters, especially (meth)acrylate copolymers, above all copolymers with vinylaromatics.

Examples of suitable polyaddition resins and/or polycondensation resins are polyesters, alkyds, amino resins, polyurethanes, polylactones, polycarbonates, polyethers, epoxy resin-amine adducts, polyureas, polyamides, polyimides, polyester-polyurethanes, polyether-polyurethanes or polyester-polyether-polyurethanes, especially polyester-polyurethanes.

of these constituents (C), the (meth)acrylate (co)polymers, especially copolymers with vinylaromatics such as styrene, possess particular advantages and are therefore used with particular preference.

The constituents (C) may be thermally self-crosslinking or externally crosslinking. Additionally, they may be curable thermally and/or with actinic radiation. The combined use of thermal curing and of curing with actinic radiation is also referred to by those in the art as dual cure.

The self-crosslinking binders (C) of the thermally curable powder coating materials and of the dual-cure powder coating materials comprise reactive functional groups which are able to enter into crosslinking reactions with groups of their kind or with complementary reactive functional groups. The externally crosslinking binders comprise reactive functional groups which are able to enter into crosslinking reactions with complementary reactive functional groups that are present in crosslinking agents. Examples of suitable complementary reactive functional groups for use in accordance with the invention are those described above.

The functionality of the self-crosslinking and/or externally crosslinking constituents (C) in respect of the reactive functional groups described above may vary very widely and depends in particular on the desired crosslinking density and/or on the functionality of the crosslinking agents employed in each case. In the case of carboxyl-containing constituents (C), for example, the acid number is preferably from 10 to 100, more preferably from 15 to 80, with particular preference from 20 to 75, with very particular preference from 25 to 70, and, in particular, from 30 to 65 mg KOH/g. Alternatively, in the case of hydroxyl-containing constituents (C), the OH number is preferably from 15 to 300, more preferably from 20 to 250, with particular preference from 25 to 200, with very particular preference from 30 to 150, and, in particular, from 35 to 120 mg KOH/g. Alternatively, in the case of constituents (C) containing epoxide groups, the epoxide equivalent weight is preferably from 400 to 2500, more preferably from 420 to 2200, with particular preference from 430 to 2100, with very particular preference from 440 to 2000, and, in particular, from 440 to 1900.

The complementary functional groups described above can be incorporated into the binders in accordance with the customary and known methods of polymer chemistry. This can be done, for example, by incorporating monomers which carry the corresponding reactive functional groups, and/or with the aid of polymer-analogous reactions.

Examples of suitable olefinically unsaturated monomers containing reactive functional groups are

c1) monomers which carry at least one hydroxyl, amino, alkoxymethylamino, carbamate, allophanate or imino group per molecule, such as

hydroxyalkyl esters of acrylic acid, methacrylic acid or another alpha,beta-olefinically unsaturated carboxylic acid, which are derived from an alkylene glycol which is esterified with the acid, or which are obtainable by reacting the alpha,beta-olefinically unsaturated carboxylic acid with an alkylene oxide such as ethylene oxide or propylene oxide, especially hydroxyalkyl esters of acrylic acid, methacrylic acid, ethacrylic acid, crotonic acid, maleic acid, fumaric acid or itaconic acid, in which the hydroxyalkyl group contains up to 20 carbon atoms, such as 2-hydroxyethyl, 2-hydroxypropyl, 3-hydroxypropyl, 3-hydroxybutyl, 4-hydroxybutyl acrylate, methacrylate, ethacrylate, crotonate, maleate, fumarate or itaconate; or hydroxycycloalkyl esters such as 1,4-bis(hydroxymethyl)cyclohexane, octahydro-4,7-methano-1H-indenedimethanol or methylpropanediol monoacrylate, monomethacrylate, monoethacrylate, monocrotonate, monomaleate, monofumarate or monoitaconate; reaction products of cyclic esters, such as epsilon-caprolactone and these hydroxyalkyl or hydroxycycloalkyl esters, for example;

olefinically unsaturated alcohols such as allyl alcohol;

polyols such as trimethylolpropane monoallyl or diallyl ether or pentaerythritol monoallyl, diallyl or triallyl ether;

reaction products of acrylic acid and/or methacrylic acid with the glycidyl ester of an alpha-branched monocarboxylic acid having 5 to 18 carbon atoms per molecule, especially a Versatic® acid, or instead of the reaction product an equivalent amount of acrylic and/or methacrylic acid, which is then reacted during or after the polymerization reaction with the glycidyl ester of an alpha-branched monocarboxylic acid having 5 to 18 carbon atoms per molecule, especially a Versatic® acid;

aminoethyl acrylate, aminoethyl methacrylate, allylamine or N-methyliminoethyl acrylate;

N,N-di(methoxymethyl)aminoethyl acrylate or methacrylate or N,N-di(butoxymethyl)aminopropyl acrylate or methacrylate;

(meth)acrylamides such as (meth)acrylamide, N-methyl-, N-methylol-, N,N-dimethylol-, N-methoxymethyl-, N,N-di(methoxymethyl)-, N-ethoxymethyl- and/or N,N-di(ethoxyethyl)-(meth)acrylamide;

acryloyloxy- or methacryloyloxyethyl, -propyl or -butyl carbamate or allophanate; further examples of suitable monomers containing carbamate groups are described in the patents U.S. Pat. No. 3,479,328 A, U.S. Pat. No. 3,674,838 A, U.S. Pat. No. 4,126,747 A, U.S. Pat. No. 4,279,833 A or U.S. Pat. No. 4,340,497 A;

c2) monomers which carry at least one acid group per molecule, such as

acrylic acid, methacrylic acid, ethacrylic acid, crotonic acid, maleic acid, fumaric acid or itaconic acid;

olefinically unsaturated sulfonic or phosphonic acids or their partial esters;

mono(meth)acryloyloxyethyl maleate, succinate or phthalate; or

vinylbenzoic acid (all isomers), alpha-methylvinylbenzoic acid (all isomers) or vinylbenzenesulfonic acid (all isomers);

c3) monomers containing epoxide groups, such as the glycidyl ester of acrylic acid, methacrylic acid, ethacrylic acid, crotonic acid, maleic acid, fumaric acid or itaconic acid, or allyl glycidyl ether.

They are preferably used to prepare the invention's preferred (meth)acrylate copolymers, especially ones containing glycidyl groups.

Higher-functional monomers of the type described above are generally used in minor amounts. For the purposes of the present invention, minor amounts of higher-functional monomers are those amounts which do not lead to crosslinking or gelling of the addition copolymers, in particular of the (meth)acrylate copolymers, unless the specific desire is to prepare crosslinked polymeric microparticles.

Examples of suitable monomer units for introducing reactive functional groups into polyesters or polyester-polyurethanes are 2,2-dimethylolethyl- or -propylamine blocked with a ketone, the resulting ketoxime group being hydrolyzed again following incorporation; or compounds containing two hydroxyl groups or two primary and/or secondary amino groups and also at least one acid group, in particular at least one carboxyl group and/or at least one sulfonic acid group, such as dihydroxypropionic acid, dihydroxysuccinic acid, dihydroxybenzoic acid, 2,2-dimethylolacetic acid, 2,2-dimethylolpropionic acid, 2,2-dimethylolbutyric acid, 2,2-dimethylolpentanoic acid, α,δ-diaminovaleric acid, 3,4-diaminobenzoic acid, 2,4-diaminotoluenesulfonic acid or 2,4-diaminodiphenyl ether sulfonic acid.

One example of introducing reactive functional groups by way of polymer-analogous reactions is the reaction of hydroxyl-containing resins with phosgene, resulting in resins containing chloroformate groups, and the polymer-analogous reaction of the chloroformate-functional resins with ammonia and/or primary and/or secondary amines to give resins containing carbamate groups. Further examples of suitable methods of this kind are known from the patents U.S. Pat. No. 4,758,632 A, U.S. Pat. No. 4,301,257 A or U.S. Pat. No. 2,979,514 A.

The constituents (C) crosslinkable with actinic radiation or by dual cure comprise on average at least one, preferably at least two, group(s) having at least one bond per molecule that can be activated with actinic radiation.

For the purposes of the present invention, a bond that can be activated with actinic radiation is a bond which on exposure to actinic radiation becomes reactive and, with other activated bonds of its kind, enters into addition polymerization reactions and/or crosslinking reactions which proceed in accordance with free-radical and/or ionic mechanisms. Examples of suitable bonds are carbon-hydrogen single bonds or carbon-carbon, carbon-oxygen, carbon-nitrogen, carbon-phosphorus or carbon-silicon single bonds or double bonds. Of these, the carbon-carbon double bonds are particularly advantageous and are therefore used with very particular preference in accordance with the invention. For the sake of brevity, they are referred to below as “double bonds”.

Accordingly, the group which is preferred in accordance with the invention comprises one double bond or two, three or four double bonds. If more than one double bond is used, the double bonds can be conjugated. In accordance with the invention, however, it is of advantage if the double bonds are present in isolation, in particular each being present terminally, in the group in question. It is of particular advantage in accordance with the invention to use two double bonds or, in particular, one double bond.

If more than one group that can be activated with actinic radiation is used on average per molecule, the groups are structurally different from one another or of the same structure.

If they are structurally different from one another, this means, in the context of the present invention, that use is made of two, three, four or more, but especially two, groups that can be activated with actinic radiation, these groups deriving from two, three, four or more, but especially two, monomer classes.

Examples of suitable groups are (meth)acrylate, ethacrylate, crotonate, cinnamate, vinyl ether, vinyl ester, dicyclopentadienyl, norbornenyl, isoprenyl, isopropenyl, allyl or butenyl groups; dicyclopentadienyl, norbornenyl, isoprenyl, isopropenyl, allyl or butenyl ether groups; or dicyclopentadienyl, norbornenyl, isoprenyl, isopropenyl, allyl or butenyl ester groups, but especially acrylate groups.

Preferably, the groups are attached to the respective parent structures of the constituents (C) via urethane, urea, allophanate, ester, ether and/or amide groups, but in particular via ester groups. Normally, this occurs as a result of customary and known polymer-analogous reactions such as, for instance, the reaction of pendant glycidyl groups with the olefinically unsaturated monomers described above that contain an acid group, of pendant hydroxyl groups with the halides of these monomers, of hydroxyl groups with isocyanates containing double bonds such as vinyl isocyanate, methacryloyl isocyanate and/or 1-(1-isocyanato-1-methylethyl)-3-(1-methylethenyl)benzene (TMI® from the company CYTEC), or of isocyanate groups with the above-described hydroxyl-containing monomers.

Alternatively, it is possible to employ mixtures of purely thermally curable constituents (C) and constituents (C) that are curable purely with actinic radiation.

Suitable constituents or binders (C) include

all the binders envisaged for use in powder clearcoat slurries curable thermally and/or with actinic radiation that are described in the U.S. patent U.S. Pat. No. 4,268,542 A1 or U.S. Pat. No. 5,379,947 A1 and in the patent applications DE 27 10 421 A1, DE 195 40 977 A1, DE 195 18 392 A1, DE 196 17 086 A1, DE 196 13 547 A1, DE 196 18 657 A1, DE 196 52 813 A1, DE 196 17 086 A1, DE 198 14 471 A1, DE 198 41 842 A1 or DE 198 41 408 A1, in the German patent applications DE 199 08 018.6 or DE 199 08 013.5, unpublished at the priority date of the present specification, or in the European patent EP 0 652 264 A1;

all the binders envisaged for use in dual-cure clearcoat materials that are described in the patent applications DE 198 35 296 A1, DE 197 36 083 A1 or DE 198 41 842 A1;

all the binders envisaged for use in thermally curable powder clearcoat materials that are described in the German patent application DE 42 22 194 A1, in the product information bulletin from BASF Lacke+Farben AG, “Pulverlacke”, 1990, or in the BASF Coatings AG brochure “Pulverlacke, Pulverlacke für industrielle Anwendungen”, January 2000; or

all the binders envisaged for use in UV-curable clearcoat materials and powder clearcoat materials that are described in the European patent applications EP 0 928 800 A1, EP 0 636 669 A1, EP 0 410 242 A1, EP 0 783 534 A1, EP 0 650 978 A1, EP 0 650 979 A1, EP 0 650 985 A1, EP 0 540 884 A1, EP 0 568 967 A1, EP 0 054 505 A1 or EP 0 002 866 A1, in the German patent applications DE 197 09 467 A1, DE 42 03 278 A1, DE 33 16 593 A1, DE 38 36 370 A1, DE 24 36 186 A1 or DE 20 03 579 B1, in the international patent applications WO 97/46549 or WO 99/14254, or in the U.S. patents U.S. Pat. No. 5,824,373 A, U.S. Pat. No. 4,675,234 A, U.S. Pat. No. 4,634,602 A, U.S. Pat. No. 4,424,252 A, U.S. Pat. No. 4,208,313 A, U.S. Pat. No. 4,163,810 A, U.S. Pat. No. 4,129,488 A, U.S. Pat. No. 4,064,161 A or U.S. Pat. No. 3,974,303 A.

The preparation of the constituents (C) has no special features as to its method but instead takes place with the aid of the customary and known methods of polymer chemistry, as described in detail, for example, in the patent documents recited above.

Further examples of suitable preparation processes for (meth)acrylate copolymers (C) are described in the European patent application EP 0 767 185 A1, in the German patents DE 22 14 650 B1 or DE 27 49 576 B1, and in the U.S. patents U.S. Pat. No. 4,091,048 A1, U.S. Pat. No. 3,781,379 A, U.S. Pat. No. 5,480,493 A, U.S. Pat. No. 5,475,073 A or U.S. Pat. No. 5,534,598 A, or in the standard work Houben-Weyl, Methoden der organischen Chemie, 4th Edition, Volume 14/1, pages 24 to 255, 1961. Suitable reactors for the copolymerization are the customary and known stirred vessels, cascades of stirred vessels, tube reactors, loop reactors or Taylor reactors, as described, for example, in the patents and patent applications DE 1 071 241 B1, EP 0 498 583 A1 or DE 198 28 742 A1 or in the article by K. Kataoka in Chemical Engineering Science, Volume 50, No. 9, 1995, pages 1409 to 1416.

The preparation of polyesters and alkyd resins (C) is also described, for example, in the standard work Ullmanns Encyklopädie der technischen Chemie, 3rd Edition, Volume 14, Urban & Schwarzenberg, Munich, Berlin, 1963, pages 80 to 89 and pages 99 to 105, and also in the following books: “Résines Alkydes-Polyesters” by J. Bourry, Paris, Dunod, 1952, “Alkyd Resins” by C. R. Martens, Reinhold Publishing Corporation, New York, 1961, and “Alkyd Resin Technology” by T. C. Patton, Interscience Publishers, 1962.

The preparation of polyurethanes and/or acrylated polyurethanes (C) is also described, for example, in the patent applications EP 0 708 788 A1, DE 44 01 544 A1 or DE 195 34 361 A1.

Examples of especially suitable constituents (C) are the (meth)acrylate copolymers containing epoxide groups, having an epoxide equivalent weight of preferably from 400 to 2500, more preferably from 420 to 2200, with particular preference from 430 to 2100, with very particular preference from 440 to 2000, and in particular from 440 to 1900, a number-average molecular weight (determined by gel permeation chromatography using a polystyrene standard) of preferably from 2000 to 20,000 and in particular from 3000 to 10,000, and a glass transition temperature (Tg) of preferably from 30 to 80, more preferably from 40 to 70 and in particular from 40 to 60° C. (measured with the aid of differential scanning calorimetry (DSC), as described in the patents and patent applications EP 0 299 420 A1, DE 22 14 650 B1, DE 27 49 576 B1, U.S. Pat. No. 4,091,048 A or U.S. Pat. No. 3,781,379 A.

The weight proportions of the constituents (A) and (B) and also, if desired, (C) in a dispersion or a solution (I) may vary very widely and are guided by the requirements of each individual case and in particular by parameters such as the solubility of the constituents (A) and (C) in (B) or the viscosity of (C). The solution or dispersion (I), based in each case on the overall amount of the solution or dispersion (I), comprises preferably

from 0.1 to 80, more preferably from 0.2 to 75, with particular preference from 0.3 to 70, with very particular preference from 0.4 to 65, and in particular from 0.5 to 60% by weight of (A),

from 10 to 99, more preferably from 12 to 95, with particular preference from 14 to 90, with very particular preference from 16 to 88, and in particular from 18 to 87% by weight of (B),

from 0 to 80, more preferably from 2 to 75, with particular preference from 2 to 70, with very particular preference from 3 to 65, and in particular from 4 to 60% by weight of (C).

The preparation of the dispersions or solutions (I) has no special features but instead takes place in a customary and known manner by mixing the above-described constituents (A) and (B) and also, if desired, (C) in appropriate mixing equipment such as stirred vessels, dissolvers, stirred mills or extruders, working in the absence of light, if appropriate, when using constituents curable with actinic radiation.

To prepare the powder coating materials of the invention, the above-described solutions and/or dispersions (I) are applied by the procedure of the invention to the surface of dimensionally stable particles (II) with partial, essentially complete, or complete evaporation of the solvent or solvents (B).

In this case, only one solution or dispersion (I) may be applied. However, it is a particular advantage of the powder coating materials of the invention and of the process of the invention that it is possible to apply at least two dispersions (I), at least one dispersion and at least one solution (I) or at least two solutions (I) simultaneously or successively to the surface of the dimensionally stable particles (II). This represents an extraordinary extension to the possibilities for varying and controlling the material composition and the distribution of the functional constituents (A) in and/or on the dimensionally stable particles (II).

In accordance with the invention it is of advantage if the solvents (B) are evaporated at temperatures below the glass transition temperature Tg or the minimum film formation temperature of the binders (C) (cf. Römpp Lexikon Lacke und Druckfarben, Georg Thieme Verlag, Stuttgart, New York, 1998, page 391, “Minimum film formation temperature (MFFT)”) of the dimensionally stable particles (II).

It is also of advantage in accordance with the invention if the average particle size and the particle size distribution of the dimensionally stable particles (II) undergo little or no change as a result of the application of the solutions and/or dispersions (I), unless such a change is deliberately aimed at. This may be the case, for example, when starting from dimensionally stable particles (II) having a comparatively low average particle size and when intending to construct a powder coating material of the invention having a relatively large average particle size. Here again, new possibilities result for the control and optimization of the preparation and composition of the powder coating materials of the invention.

In the context of the present invention, “dimensionally stable” means that, under the customary and known conditions of the storage and application of powder coating materials, the particles (II) undergo very little, if any, agglomeration and/or breakdown into smaller particles but instead essentially retain their original form even under the influence of shear forces.

The particle size distribution of the dimensionally stable particles (II) may vary comparatively widely and is guided by the particular intended use of the powder coating materials of the invention.

Preferably, the average size of the dimensionally stable particles (II) of the pigmented powder slurry is from 1 to 200 μm, more preferably from 2 to 150 μm, and with particular preference from 3 to 100 μm. The average particle size meant here is the 50% median as determined by the laser diffraction method, i.e., 50% of the particles have a diameter≦the median and 50% of the particles have a diameter≧the median.

Owing to the partial, essentially complete, or complete evaporation of the solvents (B), the powder coating materials of the invention are substantially free from organic solvents, so that they are free-flowing and easy to apply. Their residual volatile solvent content is preferably ≦15% by weight, more preferably ≦10% by weight, and with particular preference ≦5% by weight.

The composition of the dimensionally stable particles (II) may vary extremely widely. It is guided primarily by whether the powder coating material of the invention to be prepared is thermally self-crosslinking, thermally externally crosslinking, curable with actinic radiation, or a dual-cure system.

Where the dimensionally stable particles (II) are used to prepare thermally self-crosslinking powder coating materials, they comprise or consist of at least one thermally self-crosslinking binder. Examples of suitable such binders are the thermally self-crosslinking constituents (C) described above.

Where the dimensionally stable particles (II) are used to prepare thermally externally crosslinking powder coating materials, they comprise or consist of at least one thermally externally crosslinking binder. Examples of suitable such binders are the thermally externally crosslinking binders (C) described above. Preferably, the particles (II) further comprise at least one of the above-described functional constituents (A), in particular at least one crosslinking agent.

Where the dimensionally stable particles are used to prepare powder coating materials curable with actinic radiation, they comprise or consist of at least one binder curable with actinic radiation. Examples of suitable such binders are the binders (C) curable with actinic radiation which were described above. Preferably, the particles further comprise at least one of the above-described functional constituents (A), in particular at least one of the above-described photoinitiators.

Where the solid particles are used to prepare powder coating materials curable thermally and with actinic radiation, they comprise or consist of at least one dual-cure binder or at least one thermally curable binder and at least one binder curable with actinic radiation. Examples of suitable such binders are the above-described dual-cure binders (C) or the thermally curable binders (C) and the binders (C) curable with actinic radiation. The particles preferably further comprise at least one of the above-described functional constituents (A), in particular at least one of the above-described photoinitiators and/or at least one crosslinking agent.

The preparation of the dimensionally stable particles (II) has no special features in terms of its method but instead takes place with the aid of the processes and apparatus described in the above-cited prior art for the preparation of powder coating materials from the binders, in particular the binders (C), and also, if appropriate, the functional constituents (A).

The particles (II) may comprise the precursor of a powder coating material, which is to be completed using at least one functional constituent (A). For example, the clear transparent precursor of a color and/or effect powder coating material may be coated with a dispersion comprising as functional constituent (A) at least one color and/or effect pigment.

Alternatively, they may comprise an inherently ready-to-use powder coating material, whose material composition and/or whose performance properties have to be adjusted subsequently. The subsequent adjustment may be necessary, for example, if the ready-to-use powder coating material is an off-specification batch. The adjustment may also be used, alternatively, to adapt ready-to-use powder coating materials conforming to older specifications to new specifications without the need for new production.

The proportion of dispersion and/or solution (I) to dimensionally stable particles (II) may vary very widely from case to case. In any case, the ratio (I):(II) is always harmonized in such a way that all of the constituents are present in the necessary amounts for setting the particular profile of properties that is required.

It is the particular advantage of the powder coating materials of the invention and of the process of the invention that all functional constituents (A) typical in powder coating materials may be applied in this way. Accordingly, a powder coating material of the invention with a given material composition may also be prepared by different variants of the process of the invention, thereby opening up new possibilities for process optimization. Similar comments apply to the subsequent adjustment of the material composition and/or of the performance properties profile of ready-to-use powder coating materials.

Furthermore, the starting point of the process of the invention may be a “universal” powder clearcoat material (II) which is coated with a very wide variety of solutions and/or dispersions (I) depending on the intended use of the powder coating material of the invention to be prepared from it.

Very particular advantages result if the functional constituent (A) used comprises at least one color and/or effect pigment, since in this case the success of the process is immediately evident. For instance, the preparation of the powder coating materials of the invention, or the process of the invention, may be used to color or pigment and/or tint powder clearcoat materials, if, for example, the pigmentation or coloration in the first step was not in accordance with the specifications.

The application of the above-described solutions and/or dispersions (I) to the dimensionally stable particles (II), or the coating of their surface with the functional constituents (A) and, if appropriate, the constituents (C), may be carried out with the aid of customary and known processes and apparatus used for the coating of solid particles.

In accordance with the invention it is advantageous to apply the dispersions and/or solutions (I) by spraying. The dispersions and/or solutions are preferably sprayed into a fluidized bed comprising the dimensionally stable particles (II).

The fluidized bed may be generated in principle using all customary and known processes and apparatus suitable for this purpose. Preference is given to the use of fluidized bed dryers, especially spray fluidized bed dryers, spray fluidized bed coaters or spray fluidized bed granulators. Commercially customary spray granulators with a particularly turbulent, homogeneous mixing operation are particularly preferred.

The fluidized bed dryers preferably comprise customary and known atomizing units, as described, for example, by A. H. Lefebvre in “Atomization and Sprays” (1989 hpc, ISBN 0-89116-603-3). Pressure nozzles and two-fluid nozzles are preferred. Particular preference is given to double-flow or multi-flow two-fluid nozzles, as sold by the companies Schlick, Lechler, Spraying Systems, Delavan or Gericke.

During the implementation of the process of the invention, the dimensionally stable particles (II) are supplied continuously or in batches to the fluidized bed, in which they are coated with at least one dispersion and/or at least one solution (I). Where materially different dispersions and/or solutions (I) are used, they are preferably sprayed in at different locations. Where only one solution or dispersion (I) is used, it may likewise be sprayed in at different locations in order to optimize its distribution in the fluidized bed. In the case of continuous operation, a narrow residence time distribution should be ensured.

After coating, the coated dimensionally stable particles (II), or the powder coating materials of the invention, are discharged. The coated dimensionally stable particles (II) may be recycled to the fluidized bed (circulation mode), in which they are coated with the same or other dispersions and/or solutions (I). For this purpose they may also be supplied to at least one further fluidized bed dryer.

It is a particular advantage of the process of the invention that, following discharge from the fluidized bed dryer, the powder coating materials of the invention no longer require grinding and/or classifying in order for the desired particle size distribution to be established.

In addition, numerous novel possibilities arise here for the control and optimization of the process of the invention and of the material composition and of the performance properties profile of the powder coating material of the invention. Moreover, the process of the invention may be controlled in such a way that even thermally sensitive, catalytically active and/or highly reactive functional constituents (A) with which, under the conditions of the customary and known processes for preparing powder coating materials, there is a risk that they will decompose or will cause unwanted premature crosslinking reactions can be incorporated into the powder coating materials of the invention. Examples of such functional constituents (A) are crosslinking catalysts, crosslinking agents such as polyisocyanates, or thermally labile free-radical initiators.

The essential advantage of the above-described powder coating materials of the invention and of the process of the invention, however, is that they permit the provision of the mixer system of the invention.

The mixer system of the invention is used to prepare powder coating materials and/or to subsequently adjust the material composition and/or performance properties profile of powder coating materials. It serves in particular for subsequent adjustment of the shade and/or optical effect imparted by color and/or effect powder coating materials differing in chromaticity and/or intensity of the optical effects.

The mixer system of the invention comprises at least two adjustment modules (I) and at least one solids module (II).

An adjustment module (I) comprises in each case a dispersion or solution (I) comprising the above-described constituents (A) and (B) and also, if desired, (C). The functional constituents (A) may be used to adjust a very wide variety of performance properties, such as, for example, the rate of curing with actinic radiation or the thermal curing, the corrosion protection effect, the weathering stability, and/or the shade.

In accordance with the invention it is of advantage if the functional constituent (A) of an adjustment module (I) is at least one color and/or effect pigment. The adjustment modules (I) may comprise different color and/or effect pigments, resulting in a series of base color modules (I) from which it is possible to construct a paint mixing system which can be used to realize, from a few base colors, a virtually unlimited number of different shades and/or optical effects for the coatings produced from the powder coating materials of the invention.

Preferably, the material compositions of the color and/or effect powder coating materials of the invention differing in chromaticity and/or intensity of optical effects are determined with the aid of a paint mixing formula system based on the base color modules (I).

The mixer system of the invention further comprises at least one solids module (II), which comprises at least one kind, in particular one kind, of the dimensionally stable particles (II) described above. The module in question may, for example, comprise a universal powder clearcoat material. Which type of particles (II) are selected depends on the intended use of the powder coating materials and coatings of the invention produced from them.

The mixer system of the invention comprises not least at least one mixing unit for mixing the contents of at least one adjustment module (I) and the contents of at least one solids module (II) under defined proportions and temperatures. Preferably, the mixing unit comprises a fluidized bed dryer. Examples of suitable fluidized bed dryers are those described above.

To the producer of powder coating materials, the mixer system of the invention offers the key advantage that for specific end uses it is no longer necessary to prepare very large amounts of a ready-to-use powder coating material but that it is instead possible, in accordance with user requirements, to prepare specifically, or adjust, small amounts of a powder coating material which is adapted precisely to the particular end use. All of this also makes the preparation of small amounts of powder coating material by means of the mixer system of the invention economically attractive.

### EXAMPLES

### Examples 1 to 12

The Preparation of the Inventive Powder Coating Materials 1 to 12 by the Process of the Invention

Examples 1 to 12 were carried out using a fluidized bed dryer (Unilab-5) having the technical data listed in Table 1. The important process parameters are also evident from Table 1.

TABLE 1
Technical data of the fluidized bed dryer,
and the important process parameters

| Technical data: | |
|---|---|
| Diameter of the fluidized bed base (mm): | 300; |
| Atomization: | Nozzle; |
| Process parameters: | |
| Temperature of incoming air (° C.): | 40-65 |
| Temperature of outgoing air (° C.): | 25-35 |
| Spraying rate (kg/h): | 2-3 |
| Fluidization speed (m/s): | 0.4-0.8 |

### Example 1

A mixture of 125 g of a typical powder coatings methacrylate copolymer, 125 g of the color pigment C.I. Pigment Brown 24,77310 (Sicotangelb® L 1910 from BASF Aktiengesellschaft), 375 g of acetone and 500 g of glass beads (diameter 3 mm) in a sealed 1 liter glass vessel were shaken in a Skandex shaker machine for 15 minutes.

The resulting pigment dispersion, minus the glass beads, was transferred to a solution, stirred with a paddle stirrer, of 125 g of the methacrylate copolymer in 1.375 kg of acetone.

This pigment dispersion was sprayed onto 2.125 kg of an acrylate-based powder clearcoat material (acrylic powder clearcoat PA 20-0265 from BASF Coatings AG) for 110 minutes in the fluidized bed dryer, under the conditions set out in Table 1.

This gave 2.468 kg of a free-flowing, homogeneous, yellow powder coating material having particle sizes of from 2 to 100 μm and a pigment content of 5% by weight.

### Example 2

Example 1 was repeated but using a solution of 125 g of the methacrylate copolymer in 0.5 kg of acetone instead of a solution of 125 g of the methacrylate copolymer in 1.375 kg of acetone. This gave 2.442 kg of the free-flowing, homogeneous, yellow powder coating material having particle sizes of from 2 to 100 μm and a pigment content of 5% by weight.

### Example 3

A mixture of 125 g of the methacrylate copolymer of Example 1, 25 g of the color pigment C.I. Pigment Blue 15:4 (average particle size: 0.02 to 0.05 μm), 375 g of acetone and 550 g of SAZ beads (diameter: 1 to 1.6 mm) in a sealed 1000 ml glass vessel were shaken in a Skandex shaker machine for four hours. Subsequently, 100 g of the color pigment C.I. Pigment White 6,77891 (Kronos® 2220 from Kronos International) were added. The resulting mixture was shaken in the same Skandex shaker machine for a further 15 minutes.

The resulting pigment dispersion, minus the SAZ beads, was transferred to a solution, stirred with a paddle stirrer, of 125 g of the methacrylate copolymer of Example 1 in 0.5 kg of acetone. This pigment dispersion was sprayed onto 2.125 kg of the powder clearcoat material of Example 1 for 60 minutes in the fluidized bed dryer, under the conditions set out in Table 1.

This gave 2.431 kg of a free-flowing, homogeneous, blue powder coating material having particle sizes of from 2 to 100 μm and a pigment content of 5% by weight.

### Example 4

Example 3 was repeated but using, as the organic color pigment, 62.5 g of C.I. Pigment Red 149,71137 (Paliogenrot® K 3580 from BASF Aktiengesellschaft) and, as the inorganic color pigment, 62.5 g of C.I. Pigment Yellow 184 (Sicopalgelb® 1100 from BASF Aktiengesellschaft). This gave 2.435 kg of a free-flowing, homogeneous, red powder coating material having particle sizes of from 2 to 100 μm and a pigment content of 5% by weight.

### Example 5

A mixture of 125 g of the methacrylate copolymer of Example 1, 100 g of the color pigment C.I. Pigment Black (Monarch® 1400), 375 g of acetone and 550 g of SAZ beads (diameter: 1 to 1.6 mm) in a sealed 1000 ml glass vessel were shaken in a Skandex shaker machine for four hours.

The resulting pigment dispersion, minus the SAZ beads, was transferred to a solution, stirred with a paddle stirrer, of 125 g of the methacrylate copolymer of Example 1 in 0.5 kg of acetone. This pigment dispersion was sprayed onto 2.125 kg of the powder clearcoat material of Example 1 for 60 minutes in the fluidized bed dryer, under the conditions set out in Table 1.

This gave 2.438 kg of a free-flowing, homogeneous, black powder coating material having particle sizes of from 2 to 100 μm and a pigment content of 5% by weight.

### Example 6

125 g of an aluminum effect pigment (Stapa Hydrolux® from Eckhart) were introduced with stirring into a solution, stirred with a paddle stirrer, of 250 g of the methacrylate copolymer of Example 1 in 875 g of acetone. For gentle dispersion of the aluminum effect pigment, the dispersion was stirred for 30 minutes more.

The effect pigment dispersion was sprayed onto 2.125 kg of the powder clearcoat material of Example 1 for 60 minutes in the fluidized bed dryer, under the conditions set out in Table 1.

This gave 2.442 kg of a free-flowing, homogeneous, metallic powder coating material having particle sizes of from 2 to 100 μm and a pigment content of 5% by weight.

### Example 7

125 g of an effect pigment (Paliocrom® Gold L 2000 from BASF Aktiengesellschaft) were introduced with stirring into a solution, stirred with a paddle stirrer, of 250 g of the methacrylate copolymer of Example 1 in 875 g of acetone. For gentle dispersion of the aluminum effect pigment, the dispersion was stirred for 30 minutes more.

The effect pigment dispersion was sprayed onto 2.125 kg of the powder clearcoat material of Example 1 for 60 minutes in the fluidized bed dryer, under the conditions set out in Table 1.

This gave 2.44 kg of a free-flowing, homogeneous, gold-colored effect powder coating material having particle sizes of from 2 to 100 μm and a pigment content of 5% by weight.

### Example 8

A mixture of 125 g of the methacrylate copolymer of Example 1, 18.75 g of the color pigment C.I. Pigment Blue 15:4 (average particle size: 0.02 to 0.05 μm), 375 g of acetone and 550 g of SAZ beads (diameter: 1 to 1.6 mm) in a sealed 1000 ml glass vessel were shaken in a Skandex shaker machine for four hours.

The resulting pigment dispersion, minus the SAZ beads, was subsequently transferred to a solution, stirred with a paddle stirrer, of 125 g of the methacrylate copolymer in 0.5 kg of acetone. With stirring, 106.25 g of aluminum effect pigment coated with iron oxide and silicon dioxide (Variocrom® Magic Red L 4420 from BASF Aktiengesellschaft) were introduced. For gentle dispersion of the effect pigment, the dispersion was stirred for 30 minutes more.

The effect pigment dispersion was sprayed onto 2.125 kg of the powder clearcoat material of Example 1 for 60 minutes in the fluidized bed dryer, under the conditions set out in Table 1.

This gave 2.431 kg of a free-flowing, homogeneous, blue/green effect powder coating material having particle sizes of from 2 to 100 μm and a pigment content of 5% by weight.

### Example 9

Example 4 was repeated but replacing the methacrylate copolymer of Example 1 with an unmodified epoxy resin made from bisphenol A and epichlorohydrin, having an average molecular weight of 1480 and a melting range of from 79 to 87° C. (Epikote® E 1055 from Shell Resins) and replacing the powder clearcoat material of Example 1 with a polyester/epoxy powder clearcoat material from BASF Coatings AG.

This gave 2.439 kg of a free-flowing, homogeneous, red powder coating material having particle sizes of from 2 to 100 μm and a pigment content of 5% by weight.

### Example 10

A mixture of 125 g of the epoxy resin of Example 9, 125 g of the color pigment C.I. Pigment Yellow 184 (Sicopalgelb® L 1100 from BASF Aktiengesellschaft), 375 g of acetone and 500 g of glass beads (diameter 3 mm) in a sealed 1000 ml glass vessel were shaken in a Skandex shaker machine for 15 minutes.

The resulting pigment dispersion, minus the glass beads, was transferred to a solution, stirred with a paddle stirrer, of 125 g of the epoxy resin of in 0.5 kg of acetone. The resulting pigment dispersion was sprayed onto 2.125 kg of the powder clearcoat material of Example 9 for one hour in the fluidized bed dryer, under the conditions set out in Table 1.

This gave 2.435 kg of a free-flowing, homogeneous, yellow powder coating material having particle sizes of from 2 to 100 μm and a pigment content of 5% by weight.

### Example 11

125 g of the aluminum effect pigment of Example 6 were introduced with stirring into a solution, stirred with a paddle stirrer, of 250 g of the epoxy resin of Example 9 in 875 g of acetone. The resulting pigment dispersion was sprayed onto 2.125 kg of the powder clearcoat material of Example 9 for one hour in the fluidized bed dryer, under the conditions set out in Table 1.

This gave 2.439 kg of a free-flowing, homogeneous, metallic powder coating material having particle sizes of from 2 to 100 μm and a pigment content of 5% by weight.

### Example 12

125 g of the effect pigment of Example 7 were introduced with stirring into a solution, stirred with a paddle stirrer, of 250 g of the epoxy resin of Example 9 in 875 g [lacuna]. For gentle dispersion of the effect pigment, the dispersion was stirred for 30 minutes more.

The resulting pigment dispersion was sprayed onto 2.125 kg of the powder clearcoat material of Example 9 for one hour in the fluidized bed dryer, under the conditions set out in Table 1.

This gave 2.439 kg of a free-flowing, homogeneous, gold-colored effect powder coating material having particle sizes of from 2 to 100 μm and a pigment content of 5% by weight.

The powder coating materials of Examples 1 to 12 were easy to apply and gave brilliant, homogeneous, smooth coatings having very good leveling and very good mechanical properties.

What is claimed is:

1. A curable powder coating material preparable by applying at least one dispersion (I) and/or at least one solution (I) comprising
(A) at least one functional constituent of a powder coating material and
(C) at least one solvent
with partial, essentially complete or complete evaporation of the solvent or solvents (B) to the surface of dimensionally stable particles (II).

2. The powder coating material as claimed in claim 1, wherein the functional constituent (A) is molecularly disperse or colloidally soluble or finely dispersible in the solvent (B).

3. The powder coating material as claimed in claim 1 or 2, wherein the dispersion (I) and/or the solution (I) comprises
(C) at least one oligomeric and/or polymeric constituent which is molecularly disperse or colloidally soluble or finely dispersible in the solvent (B).

4. The powder coating material as claimed in any of claims 1 to 3, wherein at least two dispersions (I), at least one dispersion (I) and at least one solution (I) or at least two solutions (I) are applied simultaneously or successively to the surface of the dimensionally stable particles (II).

5. The powder coating material as claimed in any of claims 1 to 4, wherein the average size of the dimensionally stable particles (II) is from 1.0 to 200 μm.

6. The powder coating material as claimed in any of claims 1 to 5, wherein at least one of the constituents (A) and/or (C) is materially identical with at least one constituent of the dimensionally stable particles (II).

7. The powder coating material as claimed in any of claims 1 to 6, wherein the dimensionally stable particles (II) comprise a powder coating material (I) or the precursor (I) of a powder coating material.

8. The powder coating material as claimed in claim 7, whose material composition and/or whose performance properties profile is or are adjusted subsequently.

9. The powder coating material as claimed in any of claims 1 to 8, wherein the functional constituent (A) comprises crosslinking agents, color and/or effect pigments, fluorescent pigments, electrically conductive pigments and/or magnetically screening pigments, metal powders, mar resistance pigments, organic dyes, organic and inorganic, transparent or opaque fillers and/or nanoparticles and/or auxiliaries and/or additives such as UV absorbers, light stabilizers, free-radical scavengers, devolatilizers, slip additives, polymerization inhibitors, crosslinking catalysts, thermally labile free-radical initiators, photoinitiators, thermally curable reactive diluents, reactive diluents curable with actinic radiation, adhesion promoters, leveling agents, film-forming auxiliaries, flame retardants, corrosion inhibitors, free-flow aids, waxes and/or flatting agents.

10. The powder coating material as claimed in any of claims 1 to 9, wherein the solvent or solvents (B) evaporates or evaporate below the glass transition temperature Tg of the dimensionally stable particles (II).

11. The powder coating material as claimed in any of claims 1 to 10, wherein the dispersion (I) or the solutions (I) is or are applied by spraying.

12. The powder coating material as claimed in claim 11, wherein the dispersions (I) and/or the solutions (I) are sprayed into a fluidized bed comprising the dimensionally stable particles (II).

13. A mixer system for preparing curable powder coating materials as claimed in any of claims 1 to 12 and/or for subsequently adjusting the material composition and/or the performance properties profile of curable powder coating materials as claimed in any of claims 1 to 12, comprising
(I) at least two adjustment modules, each comprising a dispersion (I) or solution (I) comprising
(A) at least one functional constituent of a powder coating material and
(B) at least one solvent
and
(II) at least one solids module comprising dimensionally stable particles (II).

14. The mixer system as claimed in claim 13, comprising a mixing unit for mixing the contents of at least one adjustment module (I) and the contents of at least one solids module (II) under defined proportions and temperatures.

16. The mixer system as claimed in claim 14, wherein the mixing unit is a fluidized bed dryer.

17. The mixer system as claimed in any of claims 13 to 16, used to prepare and/or subsequently tint curable, color and/or effect powder clearcoat materials differing in chromaticity and/or intensity of optical effects.

18. The mixer system as claimed in claim 17, wherein said preparation and/or tinting is/are carried out on the basis of a paint mixing formula system.

19. A process for preparing curable powder coating materials as claimed in any of claims 1 to 12 and/or for subsequently adjusting the material composition and/or the performance properties profile of the curable powder coating materials as claimed in any of claims 1 to 12 by mixing at least one oligomeric and/or polymeric constituent with at least one functional constituent, which comprises
(1) preparing dimensionally stable particles (II) comprising at least one oligomeric and/or polymeric binder and coating them with
(2) at least one dispersion (I) and/or at least one solution (I) comprising
(A) at least one functional constituent of a powder coating material and
(B) at least one solvent
with partial, essentially complete or complete evaporation of the solvent or solvents (B).

20. The use of the curable powder coating material as claimed in any of claims 1 to 12, of the powder coating material prepared with the aid of the mixer system as claimed in any of claims 13 to 18 and/or of the powder coating material prepared by the process as claimed in claim 19 for automotive OEM finishing, for the interior and exterior coating of constructions, for the coating of doors, windows and furniture, for industrial coating, including coil coating, container coating and the impregnation and/or coating of electrical components, and for the coating of white goods, including domestic appliances, boilers and radiators.
